(19) United States
(12) Patent Application Publication
(10) Pub. No.: US 2006/0190475 A1
(43) Pub. Date: Aug. 24, 2006

(54) Group polling for consumer review

(76) Inventor: Norman Shi, Fremont, CA (US)

Correspondence Address: BRINKS HOFER GILSON & LIONE, P.O. BOX 10395, CHICAGO, IL, 60610, US

(21) Appl. No.: 11/313,254

(22) Filed: Dec. 20, 2005

Related U.S. Application Data
(60) Provisional application No. 60/637,876, filed on Dec. 20, 2004.

(51) Int. Cl. G06F 17/00

(52) U.S. Cl. 707/102

(57) ABSTRACT

Using a computer system comprising clients at which users interface to the computer system and at least one review server that maintains a collection of reviews, each associated with a presentation, a method of collecting the reviews including providing a first presentation to a first user via a first client associated with the first user; maintaining a trust network linking the first user to the other users in the trust network; receiving a request for a review from the first user via the first client; routing a request for a review to the users in the trust network who are linked to the first user in the trust network; and saving at least some of the returned reviews in the collection of review.

### RELATED APPLICATIONS

The present patent document claims the benefit of the filing date under 35 U.S.C. §119(e) of Provisional U.S. Patent Application Ser. No. 60/637,876, filed Dec. 20, 2004, which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates generally to consumer reviews and more particularly relates to a computerized system and method for soliciting members of a trust network for recommendations and reviews.

With the advent of the Internet and the multitude of Web pages of media content available to a user of the World Wide Web (the Web), there has become a need to provide users with streamlined approaches for obtaining desired information from the Web. Search systems and processes have been developed to meet the needs of users to obtain desired information, such as reviews. Numerous companies, groups, and organizations maintain Web sites with pages that provide reviews for a plethora of products, services, advice, general information and the like. These Web sites are often configured to allow reviewers to post reviews and/or provide forums for review discussion. These Web sites are also typically configured to provide consumer access to the reviews. In some instances, companies have founded their business models on accepting reviews and providing these reviews via the Web to consumers, because consumers make decisions based on recommendations and reviews they read. A recommendation may be a type of review that indicates a user's approval or disapproval of a particular product, service, or the like.

Web sites that provide recommendations and reviews are continuing to proliferate on the Web, but many of these Web sites fail their consumers in that the consumers are left unsure whether a review is trustworthy. For example, a consumer of a review generally will not know whether a reviewer has similar tastes, experiences, and expectations. If a review is relied on for which the consumer and the reviewer have disparate tastes and expectations, the consumer may be unaware of these disparate dispositions, and as a result, the consumer may be disappointed in their reliance on the recommendation or review.

Additional concerns that consumers of recommendations and reviews often have include the lack of knowledge regarding a reviewer's motivation for generating a review. Further, without knowing a reviewer's motivations for generating a review, the consumer will not know whether a recommendation or review should be relied on. For example, a reviewer may post a review that is motivated by vindication and not thoughtful and objection evaluation. Such a review is not likely to provide useful information. Moreover, traditional Web sites that collect and provide reviews often fail to provide significant motivation for reviewers to generate and post reviews. These traditional Web sites, therefore, have difficulty collecting reviews. Of course, review sites have little problem collecting favorable product reviews written by the sellers of those products, but with many aggressive marketers using the Web, many untrustworthy reviewers may come to exist.

Therefore, new apparatus and methods are needed for recommendation and review generation and review consumption that benefit both the reviewer and the consumer for their participation in the reviewing process, but that do not engender the foregoing described shortcomings.

### BRIEF SUMMARY

Systems and methods for soliciting recommendations and reviews to a query are disclosed. A computer system may be used that includes clients at which users interface to the computer system and at least one review server that maintains a collection of reviews, each associated with a presentation, a method of collecting the reviews includes providing a first presentation to a first user via a first client associated with the first user; maintaining a trust network linking the first user to the other users in the trust network; receiving a request for a review from the first user via the first client; routing a request for a review to the users in the trust network who are linked to the first user in the trust network; and saving at least some of the returned reviews in the collection of reviews.

A method for soliciting reviews may include presenting a Web presentation and a user interface to the user, wherein the user interface is configured to send a query about the Web presentation to the members of a group to solicit a set of reviews to the query, and the members of the group are included in a trust network that includes the user. Contact information regarding the group is retrieved from a contact database and is used for sending the query to the group. The group information includes at least one of a set of e-mail addresses, a set of IM (instant message) addresses, and a set of VoIP (voice over internet protocol) addresses. The contact database includes at least one of a trust network database, an e-mail list of an email system, an electronic phonebook, an electronic calendar system, or a dedicated database. Received reviews are presented to the user via the user's user interface. The reviews may be presented in at least one of an e-mail, an IM, a VoIP message, or on a Web page.

A review solicitation system may include at least one query system configured to receive a request for a query from a requester; and a review server configured to publish a request page on the query system, wherein the request page is configured to receive the request, and wherein the review server is configured to automatically send the query to a set of clients associated with a set of reviewers, wherein the reviewers are members of a trust network. The system may further include a set of review systems that is associated with the set of reviewers, wherein each review system is configured: i) to receive the query, ii) present the query to an associated reviewer, iii) receive a review for the query from this reviewer, and iv) send this review to at least one of the query systems or the review server. Each review system is associated with contact information includes at least one of a set of e-mail addresses, a set of IM addresses, or set of VoIP addresses. The system may also include a contact database configured to store the contact information, the contact database including an e-mail list of an e-mail system, an electronic phonebook, an electronic calendar system, and/or a dedicated database. The request includes at least one of a query string, a graphic, a digital audio file, or a link to a page. According to a specific embodiment, the system further includes a VoIP server configured to send the query as a VoIP message. According to another specific embodiment, the system further includes an IM server configured to receive the query from the review server and to send the query to the reviewer's system as an IM message.

A further understanding of the nature and advantages of the present invention may be realized by reference to the remaining portions of the specification and the drawings.

### BRIEF DESCRIPTION OF THE DRAWINGS

FIG. 1 is a simplified diagram of an exemplary information retrieval and communication system.

FIG. 2 is an illustration of an exemplary GUI that is configured to receive a request from a requester for generating and distributing a query.

FIG. 3A is an illustration of an exemplary window of a user interface presented to a reviewer by the review server and includes an email server that in turn includes a query.

FIG. 3B is an illustration of an exemplary window of a user interface presented to a reviewer by the review server and includes an e-mail that includes a link to a query.

FIG. 4 is an illustration of an exemplary window of a user interface presented to a reviewer by the review server and that includes a return e-mail that is configured to accept a reviewer's review.

FIG. 5 is an illustration of an exemplary browser display showing a response page that includes a query and is configured to receive a reviewer's review.

FIG. 6A is an illustration of an exemplary window of a user interface presented to a requester by the review server and includes an e-mail that may be sent to the requester and further includes a reviewer's review.

FIG. 6B is an illustration of a window of a user interface presented to a requester by the review server and includes an e-mail that includes a link to the reviewer's review.

FIG. 7 is an illustration of a browser window that includes a review page that may be served on the query system if the link in the e-mail shown in FIG. 6B is selected.

FIG. 8 is an illustration of an exemplary browser display that includes a Web page that includes a query-request button configured to launch a query-request page.

FIG. 9 is a high-level flow chart having exemplary steps for generating a query to solicit reviews responsive to the query.

FIG. 10 is another high-level flow chart having exemplary steps for generating a query to solicit reviews responsive to the query.

### DETAILED DESCRIPTION OF THE DRAWINGS AND THE PRESENTLY PREFERRED EMBODIMENTS

Introduction and System Overview

Subheadings are used herein as an aid to the reader and are not intended to supersede or limit any material in the description, drawings, or claims. Moreover, embodiments of the invention are described, by way of example, not limitation. It is to be understood that the invention is of broad utility and may be used in many different contexts.

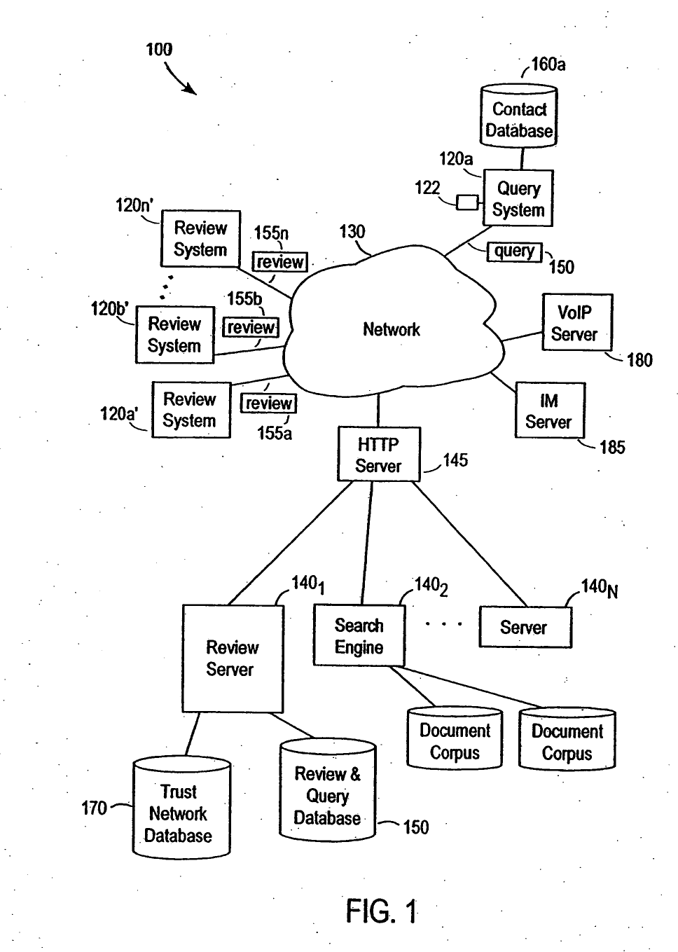

FIG. 1 is a simplified diagram of an exemplary information retrieval and communication system 100. In communication system 100, one or more client systems 120 may be coupled through a network 130, such as the Internet or an intranet (e.g., a LAN or WAN), to a set of server systems 140. The set of client systems may include a query system 120a, and may include one or more review systems 120a′-120n′. The set of server systems may include a review server 140₁, a search engine 140₂ and/or other servers. The query system and the review systems may be configured to communicate with any of the server systems 140 via a Hypertext Transfer Protocol (HTTP) server 145 or the like to request, access, receive, retrieve, and/or provide a set of solicitations for reviews, a set of reviews responsive to the solicitations or the like. As referred to herein, a set includes one or more elements. It should be understood that while servers 140₁ and 140₂ are referred to respectively as a review server and a search engine, these severs may be configured for header utility beyond providing review services and searching services. These servers are described in further detail below.

Several elements of communication system 100 shown in FIG. 1 include conventional, well-known elements that need not be explained in detail herein. For example, one or more of the client systems 120 may include a desktop personal computer, a workstation, a laptop, a PDA (personal digital assistant), a network computer, a cell phone, any wireless application protocol (WAP) enabled device or any other computing device capable of interfacing directly or indirectly to a network, such as the Internet. Client systems 120 would typically run an e-mail program, such as Microsoft's Outlook ExpressTM software, and a browsing program, such as Microsoft's internet Explorer™ browser, Firefox™ browser, Netscape's Navigator™ browser, Mozilla™ browser, Opera™ browser, a WAP-enabled browser in the case of a cell phone, a PDA or other wireless device allowing a user of a client system to access, process, and view content available to it from server systems 140 over network 130. Client systems 120 may also use less interactive interfaces, such as computer-to-computer XML interfaces or the like. The client systems also typically include one or more user interface devices 122 (one of which is shown in FIG. 1) that may include one or more of a keyboard, a mouse, a roller ball, a touch screen, a touch pad, a pen or the like, for interacting with a graphical user interface (GUI) provided by the browser on a display (e.g., monitor screen, LCD display, etc.), in conjunction with pages, forms and other information provided by server systems 140 or other servers.

The network 130 may be the Internet, which refers to a specific global internetwork of networks. However, it should be understood that other networks 130 may be used instead of or in addition to the Internet, such as an intranet, an extranet, a virtual private network (VPN), a non-TCP/IP based network, any LAN or WAN or the like.

According to one embodiment, client systems 120, server systems 140, and their respective components may be operator configurable using an application including computer code run using one or more central processing units, such as those manufactured by Intel, AMD or the like. Computer code for operating and configuring client systems 120 to communicate, process, and display a Web page (e.g., a query Web page, a query-result Web page, etc.) may be downloaded and stored on a hard disk, but the entire program code, or portions thereof, can also be stored on any other volatile or non-volatile memory medium or device as is well known, such as a ROM or RAM, or provided on any media capable of storing program code, such as a compact disk (CD) medium, a digital versatile disk DVD) medium, a floppy disk, and the like. Alternatively, the entire program code, or portions thereof, may be transmitted and downloaded from a software source, e.g., from one or more of server systems 140 to client systems 120 over network 130 using a communication medium and protocols (e.g., TCP/IP, HTTP, HTTPS, Ethernet, or other conventional media and protocols). As referred to herein, a server system may include a single server computer or number of server computers that are configured to operate collectively as a server.

It should be appreciated that computer code for implementing aspects of the present invention can be C, C++, HTML, XML, Java, JavaScript, or any other suitable scripting 20 language (e.g., VBScript), or any other suitable programming language that can be executed on client systems 120 and/or sewers systems 140 or compiled to execute on client systems 120 and/or system servers 140. In some embodiments, no code is downloaded to client systems 120, and needed code is executed by a server, or code already present at client systems 120 is executed.

It should also be understood, that a user can be a human user interacting with a user interface of a client system that processes a user request, such as a query 150. The user could also be mother computer process or another computer system that generates the query. In the latter instance, it is likely that the requesting computer user will also programmatically process the results of the query, but it may instead be the case that a computer user makes a query and a human user is the ultimate recipient of the query result.

Query Generation

The query system 120a may be configured to receive a request from a requester to generate a query 150. The query 150 may include a solicitation for a set of reviews and may be sent to one or more select review systems 120a . . . 120f to solicit the reviews. A reviewer (e.g., a user of a review system) who receives the query via their associated review system may generate a review based on the query and direct their review system to send their review to review server 140₁ and/or query system 120a. Each of the elements of system 100 is described in further detail below. For convenience, the generation of a query is described first below, the transmission of a query to one or more reviewers is described second below, and the generation of one or more reviews that are responsive to a query are described thereafter.

Requesters include users the query system and who provide entries to the query systems for generating a query. Requesters may me human users or automatons. If the requester is an automaton, the automaton may generate a query for review solicitation, but a human user may be one of the recipients of review via their associated query system. A request included in a query may include text, images, links or the like. A review may include one or more of text, images, links providing information from the reviewer to the requester, and possibly also to later requesters. A presentation presented to a requester and/or a reviewer may include a web presentation that may include an e-mail that includes the request, an e-mail with a link to the request, a web page or the like. Request systems and review systems may include a desktop personal computer, a workstation, a laptop, a PDA (personal digital assistant), a network computer, a cell phone, any wireless application protocol (WAP) enabled device or any other computing device capable of interfacing directly or indirectly to a network, such as the Internet. A select group of reviewers include users that are associated with the requester, such as in a trust network, wherein the requester and the reviewers are associated with links. The members of the trust network may be known to each other, or may otherwise be associated with each other. For a detailed understanding of trust networks see U.S. Pat. No. ______ (U.S. Provisional Patent Application No. 60/553,577), filed Mar. 15, 2004, titled “Search System and Methods With Integration of User Judgments Including Trust Networks;” U.S. Pat. No. ______ (U.S. Provisional Patent Application No. 60/621,283.), filed Oct. 28, 2004, titled “Search System and Methods With Integration of User Judgments Including Trust Networks;” and U.S. Pat. No. ______ (U.S. patent application Ser. No. 10/942,335), filed Sep. 15, 2004, titled “Automatic Updating of Trust Networks In Recommender Systems,” each of which is owned by the owner of the current application, and each of which is incorporated by reference in its entirety herein for all purposes.

More specifically, a query, as referred to herein, includes a request for information that is desired by a requester. A query may include a request for the review of a product or a service that the requester is considering purchasing. For example, a requester may desire reviews for a restaurant at which the requester is contemplating eating, or the requester may desire reviews for a television set the requester is contemplating purchasing. A query may also include a request for information in general, such as the review of a park the requestor intends to visit, and the recommendation for a trail in the park for scenic hiking. The forgoing examples are merely illustrative of queries for which a requester may solicit information. Indeed, a wide variety of products, services, subjects and the like for which a requester may request a review should be apparent to one of ordinary skill in the art.

The query system 120a may be configured to receive a request from a requester to generate a query. The query system, on receipt of the request, may generate the query, or the query system may send query information included in the request to review server 140₁ to generate the query. A request may be entered by the requester via one or more of a variety of graphical user interfaces (GUIs) displayed on the display of query system 120a. One GUI configured to receive a request for generation and distribution of a query may include one or more Web pages published by a server, such as review server 140₁, a Yahoo! Property server or other server. Another GUI configured to receive a request for generating and distributing a query may include an e-mail window published, for example, by an e-mail program running on the query system, on a server, such as review server 140₁, or other computer system or server.

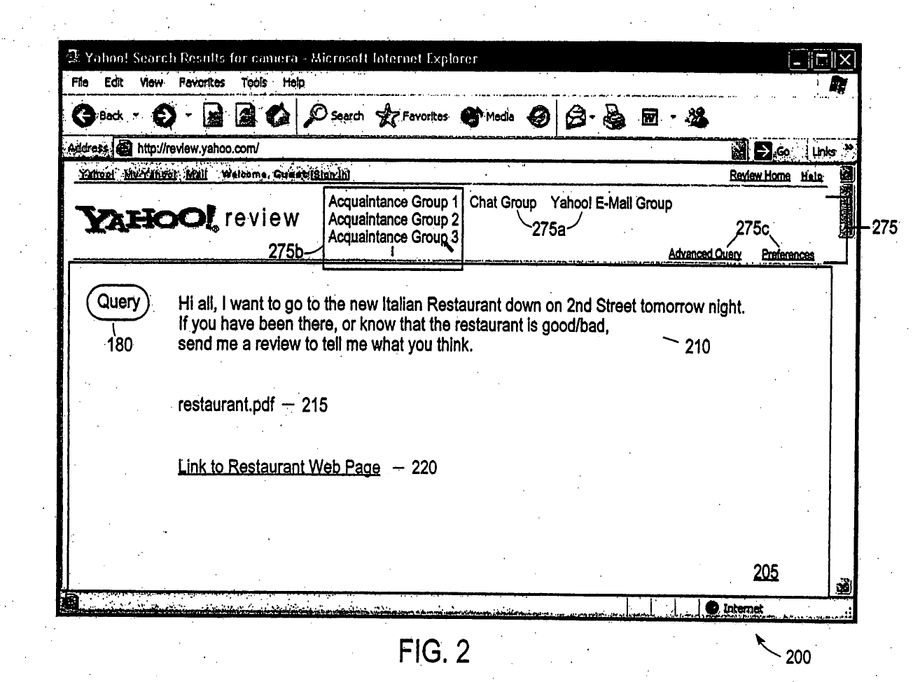

FIG. 2 is an illustration of a GUI 200 that may be configured to receive a request from a requester for generating and distributing a query according to one embodiment of the present invention. It should be understood that GUI 200 is shown for illustrative purposes. The GUI may be arranged in a variety of configurations and may include a variety of field windows, screen buttons, links and the like for receiving a request and its associated query information from a requester.

The GUI 200 is a query page that is served by the review server or other server to query system 120a. The query page may be an HTML page or the like, and the review server may be an HTML server or the like. The query page includes a field window 205 that is configured to receive query information in the form of a query string (e.g., text), image data (e.g., graphical images, such as video or the like), audio data, a link that points to a page (such as a Web page)) or the like. For example, a requester may enter a query string 210 in field window 205 that includes “Hi all, I want to go to the new Italian Restaurant down on 2nd Street tomorrow night. If you have been there, or know that the restaurant is good/bad, send me a review to tell me what you think.” According to a further and/or alternative example, the requester may enter a graphic 215 of the restaurant. The graphic may include a screen capture of the restaurant from a Web page or the like. The requester may also place a link in the field window that includes a URL that paints to the Web page of the restaurant. While GUI 1200 is shown as including a single field window configured to receive query information in a variety of formats, the GUI may include a number of field windows each configured to receive a select form of query information.

While GUI 200 has been described as including a field window configured to receive query information, the GUI need not include a field window at all, but may include any means (e.g., any means in use at the time) that may be configured to receive query information from a requester. For example, GUI 200 may be the Web interface (e.g., Web page) of a voice over internet protocol (VOIP) system 180 configured to receive an audible query from a user. A Web interface for the VoIP system may include a prompt that prompts the requester to audibly speak their query, which may be substantially instantaneously sent to the review server 140₁, and/or one or more select review systems 120a′ . . . 120n′. Alternatively, or additionally, GUI 200 may be the Web interface (e.g., Web page) of a text messaging system 185 (e.g., instant messaging system) configured to receive query information, generate a query, and substantially instantaneously transfer the query as a text message to review server 140₁ and/or one or more select review systems 120a′ . . . 120n′.

As described briefly above, a query (such as query 150) may be transmitted to a select group of the review systems and thereby transmitted to the users of these systems (e.g., reviewers). It should be understood that while embodiments of the present invention describe sending a review to a review system, a review may be sent to a computer system (e.g., an email server) that is associated with a reviewer or allocates services to others and the reviewer (user accounts and e-mail storage) and that may be not necessarily associated with any given review system, but may be retrieved from a review system associated with the reviewer, or which may be retrieved from any of the review systems.

A select group of reviewers associated with the select group of review systems may be members of a trust network, a mailing list, a requester defined list, a server defined list, a query system defined list, a mail group (e.g., a Yahoo! mail group) and/or a discussion group (e.g., a Yahoo! discussion group), associated with a given e-mail extension, members of VoIP list, members of an IM buddy list or the like. Reviewers who are members of these groups may he acquainted with the requester. For example, these reviewers may include people who are known to the requester, friends, associates, family, members of known groups, co-workers, or others. As reviewers in these groups are generally associated with the requester, the reviewers are motivated to provide reviews to queries, for example, providing recommendations, to maintain good relationships with the requester. Moreover, as the reviewers are also motivated to provide thoughtful and considered analysis in their reviews.

The query system 120a may be configured to store and/or access group information for one or more groups that may receive a query from a requester. For example, the query system may include, or may be coupled to, one or more contact databases 160 that include group information for reviewers that may receive a query from a requester. Alternatively, or additionally, review server 140, may include, or may be coupled to, one or more contact databases 170 that include group information for reviewers that may receive a query from a requester. Group information stored in contact database 160 and/or contact database 170 may include contact information for recipients. For example, the group information may include one or more lists of e-mail addresses for respective groups of reviewers. The group information may also include a group identifier that may be used to retrieve e-mail addresses or the like from a database. For example, contact database 160 and/or contact database 170 may include group identifiers for groups of reviewers, wherein the group identifiers may be used to identify a list of e-mail addresses stored in one or both of the contact databases or other databases. The group identifiers may include the names of groups, numbers to identify groups, codes to identify groups or the like. For example, a requester may maintain groups with the group identifiers: car discussion group, co-workers, softball group or the like that may be stored in one or both of the contact databases. The group information may be an e-mail list of an e-mail system, an electronic phonebook, an electronic calendar system, a dedicated database or the like. Other known forms for the group information may also be used.

A query may be sent to one or more of the foregoing types of groups listed above. The review server and/or the query system may be configured to provide a requester with a variety of means to select one or more groups to receive a query. For example, GUI 200 may include one or more selection means 175 for selecting a group to receive a query. The selection means may include a set of control buttons 275a, a set of menus 275b (e.g., drop down menus, floating menus or the like), a set of links 275c that point to one or more pages with selection means, or other selection means that will be readily known to those of skill in the art or that are in use at the time. A given selection means (e.g., a given button of set 275a) may be associated with a given group of reviewers in a predefined e-mail list. If a selection means (e.g., one of buttons 275a) is activated by a requester, the query system may retrieve contact information (e.g., e-mail addresses) of a group of reviewers associated with the control button, or the query system may retrieve one or more group identifiers that may be subsequently used to retrieve the contact information.

Links 275c may point at one or more pages that are configured to permit a requester to manage their groups. For example, pages (not shown) may be published by the review server that permit a requester to change the names of groups, associate groups with the selection means, create groups, delete groups, edit group membership or the like.

The GUI 200 includes at least one control button 280 that may be configured to initiate the sending of a query. The GUI 200 may also include control device (not shown) for sending a query in one or more select formats, such as an e-mail, an IM, a VoIP message, or the like. If control button 280 is activated, the query system may retrieve the e-mail addresses or a group identifier of the one or more groups selected by the requester using selection means 275.

Activation of control button 280 may also trigger the query system to e-mail a query or a link to the query to the select review systems and/or the review server. The select review systems include those review systems associated with the members of a group of reviewers selected to receive a query. Alternatively or additionally, query information may be transferred from the query system to the review server for generation of a query and distribution of the query to the select review systems. According to the latter, query information, such as the query information entered on GUI 200 or the like, may be transferred from the query system to the review server in a variety of formats. For example, the query information may be transferred in a URL using HTML or the like, an e-mail, an IM, a VoIP message or in other formats in use at the time.

A received URL, e-mail, etc. may include a query string, graphics information, digital audio information, destination information or the like. The destination information may include the e-mail addresses of the group of reviewers selected to receive the query, or may include a group identifier that may be used to extract the e-mail addresses or the like from contact database 160 and/or contact database 170.

The review system may be configured to store the query information in a review database 175. According to some embodiments, a requester may be presented with an option (e.g., on GUI 200) to select whether their query information is to be stored in the review database. Stored queries and stored reviews, which are responsive to the queries, may be accessible via a Web site that may be associated with the review server and the review database.

The review server may e-mail the query, or a link to the query, to the select review systems. Prior to sending the query, the review server may be configured to extract e-mail addresses for the e-mails from the received query information. Alternatively, the review server may be configured to retrieve the e-mail addresses from contact database 160 and/or database 170 based on group information (e.g., one or more group identifiers) received in the received query information.

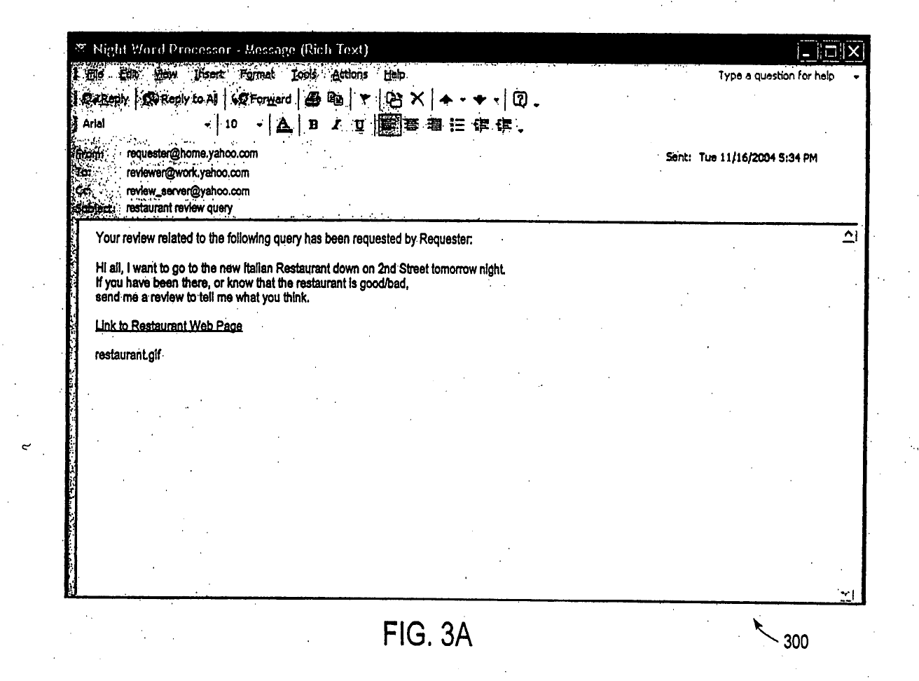

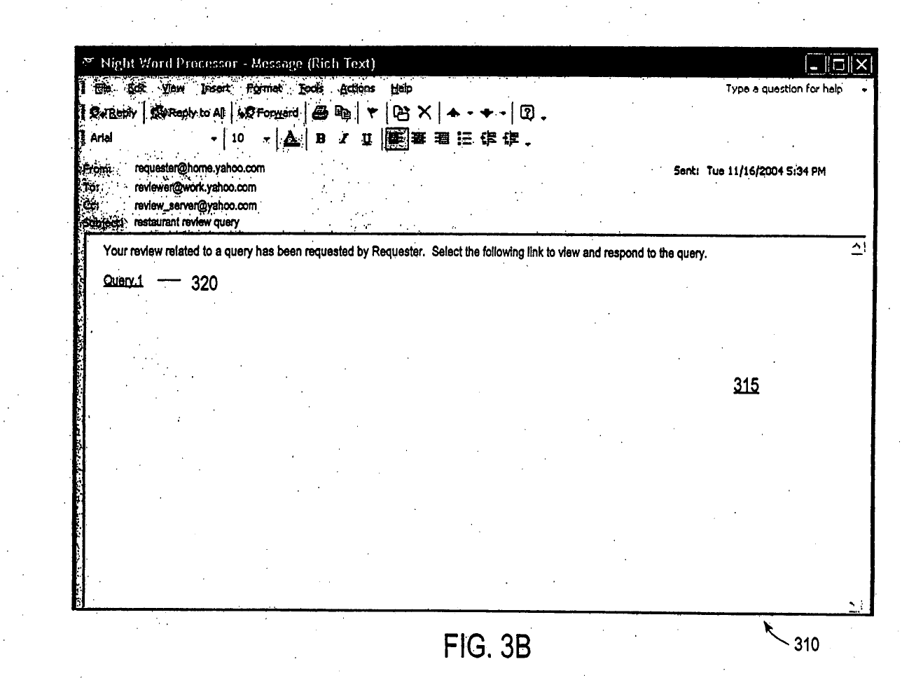

FIG. 3A is an illustration of a window 300 of a user interface presented to a reviewer by the review server and includes an e-mail 305 that includes query 150 according to one embodiment of the present invention. FIG. 3B is an illustration of a window 310 that includes an e-mail 315 that includes a link 320 to query 150 according to an alternative embodiment of the present invention. These e-mails may be sent by the review server or the query system to the select review systems as described above. These e-mails are described in further detail below.

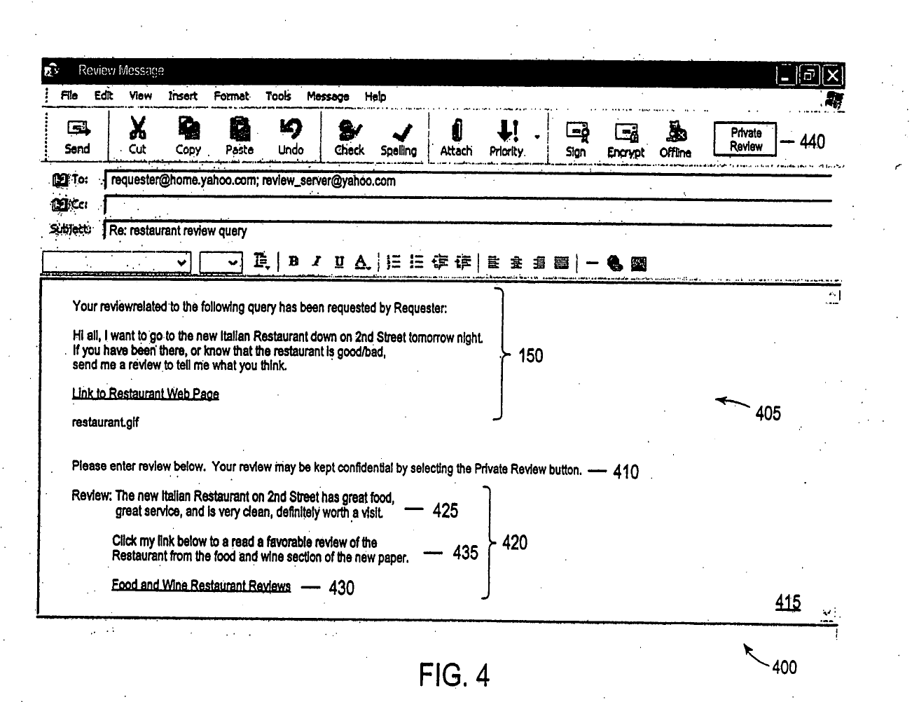

FIG. 4 is an illustration of a window 400 of a user interface presented to a reviewer by the review server and that includes a return e-mail405 that may be configured to accept a reviewer's review. The return e-mail may be generated by a review system if the reviewer decides to respond to the query. E-mail window 400 may be generated and displayed on the display of the review system if the reviewer selects the reply option, the forward option (see FIG. 3A) or the like in e-mail window 300.

The e-mail 405 may include an instruction 410 that instructs the reviewer to enter their review in field window 415. The field window may be configured to receive a review string (e.g., text), links, graphics, audio files and the like. An example review 420 that may be responsive to query 150 may include a review string 425, “The new Italian Restaurant on 2nd Street has great food, great service, and is very clean, definitely worth a visit.” The review may also include a link 430 and instructions 435 to select the link to publish a Web page of a local newspaper review of the restaurant.

The window 400 may include a reviewer selection button 440 that may be selected for maintaining the confidentiality of a review, or more specifically, for selecting not to have a review made accessible on a Web site (not shown) that may be associated with the review server arid the review server's contact database. If the selection button is not selected, the review and its associated query may be made accessible via the Web page to other reviewers, other requesters or the like. If the review selection button is selected, the review system may be configured to transfer the reviewer's review to the review server for storage in the review database. The review may be retrieved from the review database if requested by a user using the Web site associated with the review server. While reviewer selection button 440 has been described as providing reviewers an option for maintaining the confidentiality of a review, the reviewer selection button, if selected, may be configured to provide the option for having a review stored in the review database and made available to others via the described Web site. That is, the system default may be to transfer reviews to the review server and the review database for access by others. According to some embodiments, the review may be sent to the review server and may be kept confidential if the reviewer has requested such. For example, the review server may be configured to send the review to the requester instead of the review being sent “directly” to the reviewer.

The instruction 410 on page 400 may inform the reviewer of their option to keep their review confidential. As the reviewer has an option to keep their review confidential, the reviewer may be provided with an additional 10 incentive to provide a thoughtful and considerate review, especially if the reviewer intends to send a negative review to a requester.

As described briefly above, e-mail 315 may include a link 310 to query 150. The link may include a URL that points to a response page that includes the query. The response page may be served to the review system by the review server. The Web page may include means for a reviewer to enter their review on the review page and have their review sent to the query system. This Web page may also include selection means for selecting whether to keep a review confidential or have the review made available on a Web page accessible by others.

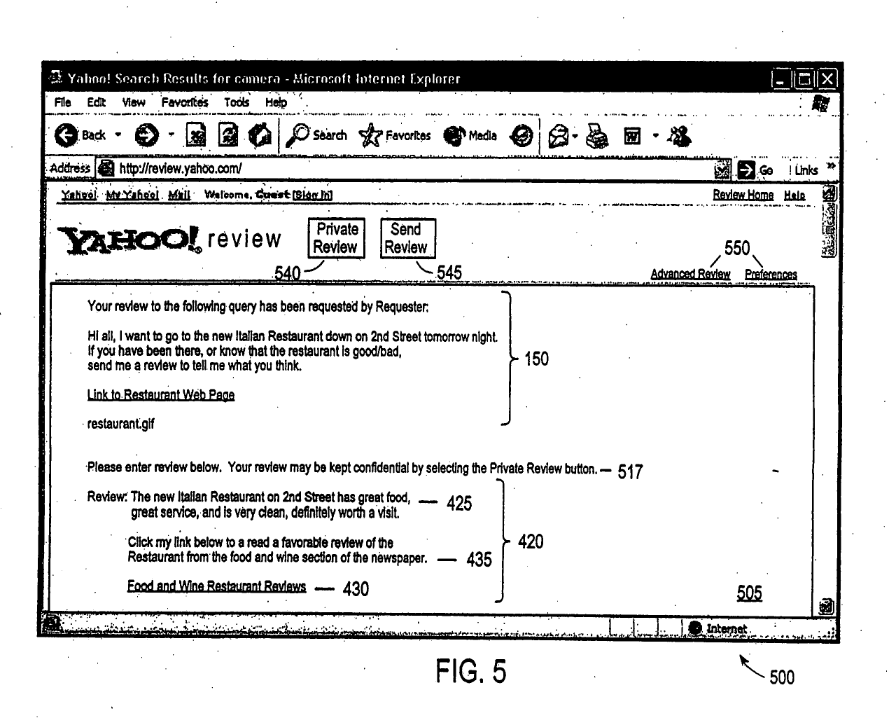

FIG. 5 is an illustration of an exemplary browser display showing a response page 500 that includes query 150 and may be configured to receive a reviewer's review. Review page 500 is shown for illustrative purposes. It will be understood by those of ordinary skill in the art that the review page may be arranged in a variety of configurations and formats and may include a variety of field windows, screen buttons, links and the like for entering a review and selecting to have the review sent to a requester. The response page 500 includes a field window 505 that includes the query 150. The field window may be configured to receive the reviewer's review 420. The Web page may include an instruction 517 that instructs the review to enter their review in the field window. The review window may be configured to receive a review string, a graphic, a digital audio file, a link or the like. As illustrated, the review 420 includes review string 425, link 430, and instruction 435 for selecting the link.

Response page 500 may include a selection button 540 selectable by the reviewer for keeping their review confidential. That is, if the selection button is selected by the reviewer, the reviewer's review will not be posted on the Web site associated with the review server and its associated contact database. The selection button may be a control button or the like. While the selection button is described as being configured to prevent a review from being posted on the Web site, the selection button may alternatively be configured to allow the review to be posted on the Web site. That is, the system default may be to not post the review, rather than to post the review. Review page 500 may include a selection button 545 for sending the review to the requester and/or to the review server. The selection button may include a control button or the like. The review may be sent in an email to me requester and/or the review server. Alternatively or additionally, a link to the review is sent in an e-mail to the requester. Such e-mails are described in further detail below.

The review page 500 may include additional control devices (not shown) that are configured to permit a review to select whether to send a review as an e-mail, an IM, a VoIP message or other message type, such as a message type in use at the time. The review page may also include one or more links 550 to one or more additional Web pages that may be configured to provide reviewers with advanced review options and review preferences, such as sending the review to other reviewers or the like, sending the review as an e-mail, an IM, a VoIP message or the like. It should be understood that review page 500 is shown for illustrative purposes, and that the review page may be arranged in a variety of configurations and formats as will be understood by those of skill in the art.

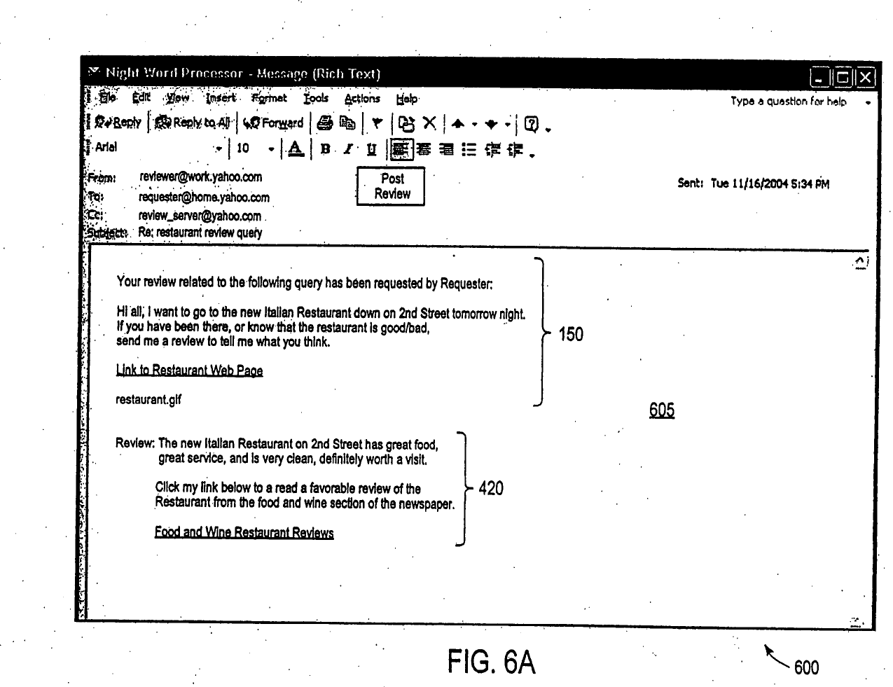

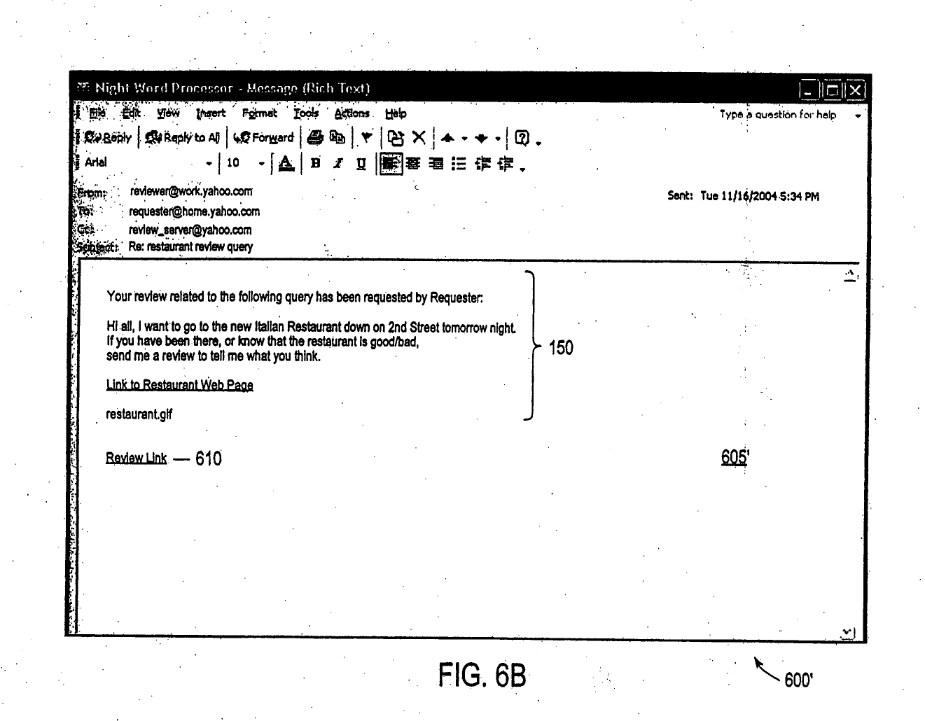

FIG. 6A is an illustration of a window 600 of a user interface presented to a requester by the review server and includes an e-mail 605 that may be sent to the requester and that includes the reviewer's review. The e-mail 605 may include a control button 615 for selecting to post the review and the query on the review server's Web site for access by other reviewers, requesters or the like. If the control button is selected, the review and the query may be sent in an e-mail or the like, to the review server for storage in the review database.

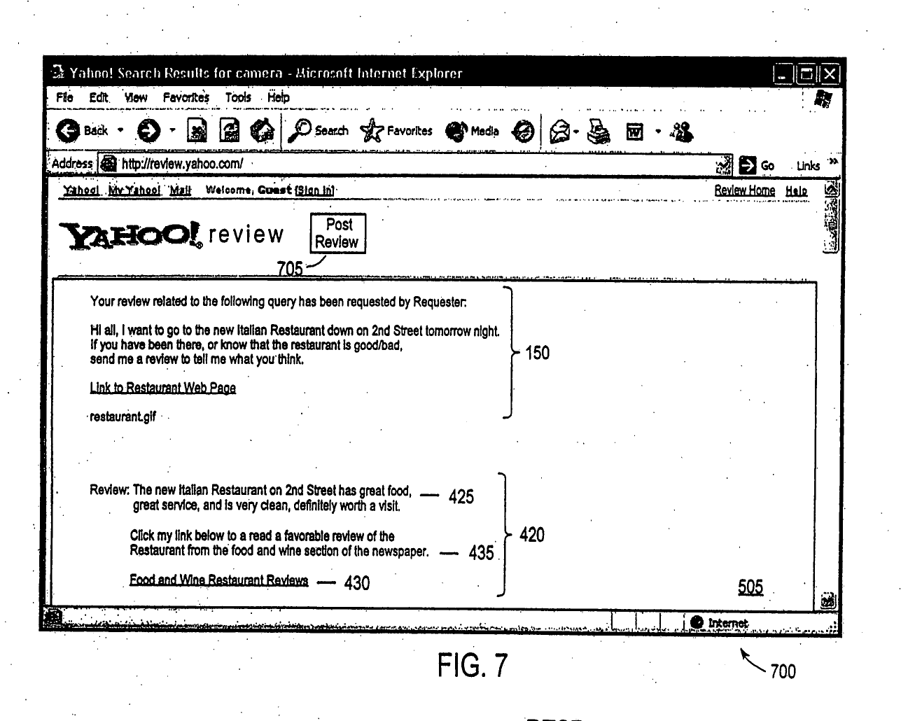

FIG. 6B is an illustration of a window 600′ that includes an e-mail 605′ that includes a link 610 to the reviewer's review. The link may include a URL that 5 points at a Web page that includes the review. If the link 610 is selected, the URL may be sent to the review server, which may serve the Web page to the query system. FIG. 7 is an illustration of a browser window that includes a review page 700 that may be served to the query system if link 610 is selected. According to the example being considered, review page 700 may include the query 150, the review 425, the link 430 and the instruction 435 for selecting the links. The review page may 25 include a selection button 705 that provides a reviewer with an option for having a review and query posted on the review server's Web page for access by others. It is to be understood that e-mail 605, e-mail 605′, and review page 700 are illustrative of GUIs that may be used for providing a review to a requester. The GUIs may have a variety of configurations, formats, and provide a variety of requester selectable options for managing reviews. Those of skill in the art will know of other interfaces that may be used to present a review result to a requester, and such interfaces are considered to be included in the purview and scope of the present invention.

According to one embodiment, a review received by a reviewer may be in an IM, a VoIP message or in another message format in use at the time. The IM and/or VoIP may include user selectable options for posting the review and the query on the review server's Web site.

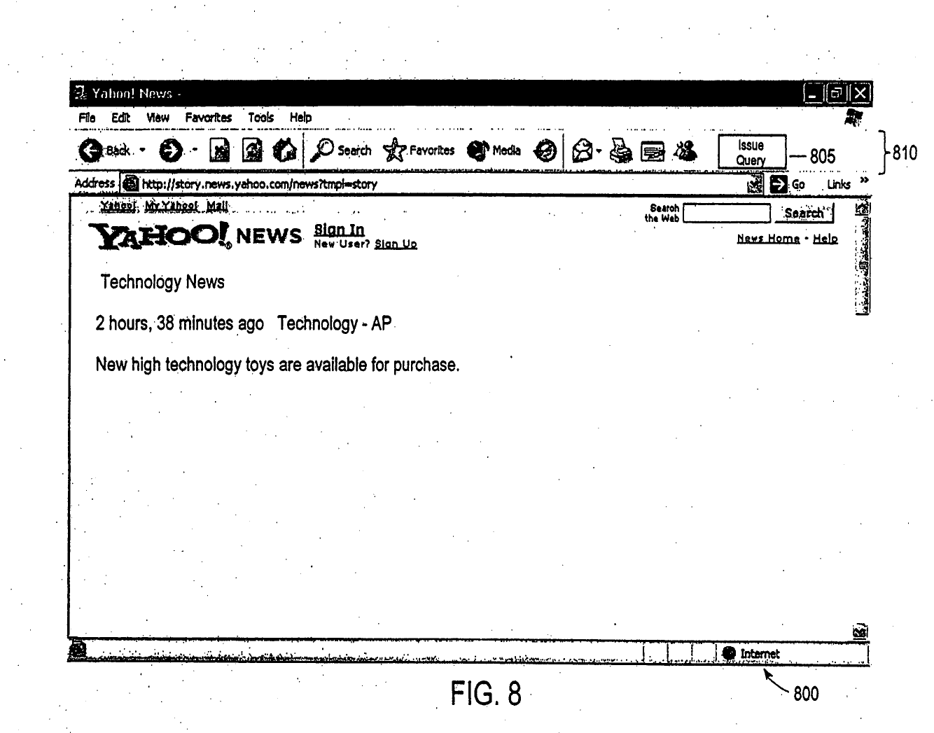

FIG. 8 is an illustration of a browser display that includes a Web page 800 that includes a query-request button 805 configured to launch Web page 200. Query-request button 805 may include a link that a user may select to launch Web page 200 or the like. The review-selection button may be in a toolbar 810, adjacent to a text portion of the Web page, adjacent to or in a banner and/or 20 the like. Web page 800 may be any Web page served by a server, such as the search engine 140₂, a Yahoo! property server, or other server.

As illustrated, query-selection button 805 is configured to initiate the generation of a query and initiate sending the query to a select group of reviewers. The generated query may be sent to the select group of reviewer as described above. The reviewers in the select group may be managed by the requester via a Web page or the like that may be launched by one or more selection buttons 810.

The query may be generated and sent via a single activation of the query-selection button. For example, if the query-activation button is a screen button and the screen button is pressed a single time, then the query may be generated and sent.

The query may include solicitations for reviews for one or more pieces of information on Web page 800. For example, a query may be generated that solicits reviews for an article, product, service, or the like on the Web page.

More than one query-selection button 805 also may be placed on a Web page and may be respectfully associated with select pieces of information on the Web page. For example, a query-selection button may be associated with each abstract of a set of abstracts served by search engine 140₂ or the like. Alternatively, the query-selection button may be respectively associated with different ads, articles, products, services, etc. on a Web page. Each query-selection button may be configured to launch a query for the information associated with the query-selection button. According to one embodiment, query-selection button may include a menu (e.g., a drop down menu, a floating menu or the like) that is configured to provide identifiers of one or more of groups that may be selected to receive a query for information on the Web page.

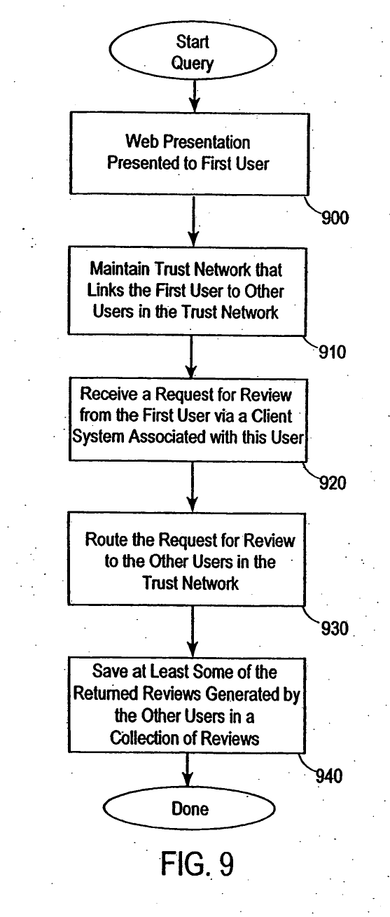

FIG. 9 is a high-level flow chart having steps for generating and distributing a query to solicit and collect reviews responsive to the query according to one embodiment of the present invention. The high-level flow chart is merely exemplary, and those of skill in the art will recognize various steps that may be added, deleted, and/or modified and are considered to be within the purview of the present invention. Therefore, the exemplary embodiment should not be viewed as limiting the invention as defined by the claims. A computer system may be used and may include clients at which users interface to the computer system and at least one review server maintains a collection of reviews, each review being associated with a presentation. At 900, a first presentation is provided to a first user via a first client associated with the first user. The presentation may include a web presentation, such as a web page presentation. At 910, a trust network is maintained that links the first user to the other users in the trust network. The users in the trust network may be associated with or known by the first user. At 920, a request for a review is received from the first user via the first client. The request for review may be a request for information related to the presentation and may include a web presentation, such as a web page presentation. At 930, a request for a review is routed to the users in the trust network who are linked to the first user in the trust network. The request for the review may be sent in an e-mail, an IM, a VoIP message. Alternatively, or additionally, the request for the review may be pointed at by a link that is sent in the email message or the like. At 940, at least some of the returned reviews are saved in a collection of reviews. One or both of the first user and the users in the trust network may be presented with an option for having the reviews and the query made accessible for other users via a Web site.

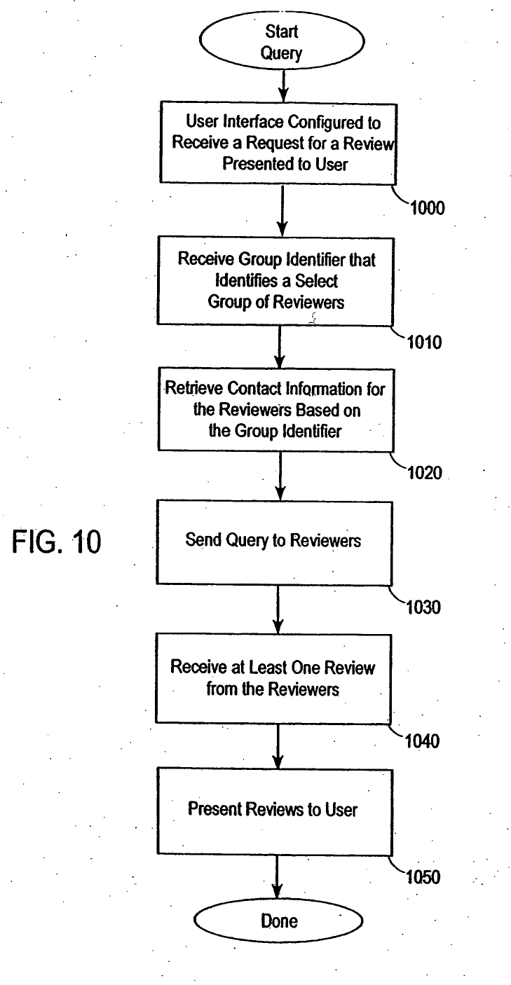

FIG. 10 is a high-level flow chart having steps for creating a query to solicit reviews responsive to the query according to another embodiment of the present invention. The high-level flow chart is merely exemplary, and those of skill in the art will recognize various steps that may be added, deleted, and/or modified and are considered to be within the purview of the present invention. Therefore, the exemplary embodiment should not be viewed as limiting the invention as defined by the claims. At 1000, a user interface is presented to a user and is configured to receive a query request from the user. The user interface may be a Web page having one or more field windows, links, user selection buttons or the like configured to receive the query request. At 1010, a selection for a group identifier is received from the user via a user selection button, such as one or more user selection buttons, links or the like. The group identifier is configured to identify a select-member group of a plurality of member groups. According to one embodiment, the members of the plurality of member groups associated with the user or are known by the user. The group identifier may include a group name, a group number, a group code or the like. At 1020, contact information for the select-member group is retrieved from a contact database based on the group identifier. At 1030, the query request is sent to the members of the select-member group to solicit a set of reviews to the query. The query is sent to these members based on their contact information retrieved from the contact database. At 1040, a set of reviews are received from at least one of the members of the select-member group. At 1050, the set of reviews are presented to the user.

It is to be understood that the examples and embodiments described above are for illustrative purposes only and that various modifications or changes in light thereof will be suggested to persons skilled in the art and are to be included within the spirit and purview of this application and scope of the appended claims. For example, while query systems and review systems have been respectively described as being associated with specific query and review function, the query systems may be configured to operate as review systems and the review systems may be configured to operate as query systems dependent, for example, on the functionality requested by a user of the systems at any given time. Therefore, the above description should not be taken as limiting the scope of the invention as defined by the claims.

1. A method of collecting reviews over a network, the method comprising:
providing a first presentation to a first user via a first client associated with the first user;
maintaining a trust network linking the first user to other users in the trust network;
receiving a request for a review from the first user via the first client;
routing a request for the review to the users in the trust network linked to the first user; and
saving at least one of the returned reviews on at least one review server that maintains a collection of reviews, wherein each saved review is associated with the first presentation.

2. The method of claim 1, wherein the first presentation relates to at least one selected from the group comprising a product, a service, an offering, a creative work for reviewing or selling, and/or a web page.

3. The method of claim 2, wherein the creative work is one selected from the group comprising a book, a movie, and/or an art work.

4. The method of claim 1, wherein the first client is an HTTP client.

5. The method of claim 4, wherein the HTTP client is a browser.

6. The method of claim 1, wherein the request for the review is a query about the first presentation.

7. The method of claim 1, wherein the other users comprise humans and automatons.

8. The method of claim 1, wherein the trust network is embodied in collection of user-user links.

9. The method of claim 8, wherein the user-user links are embodied in at least one selected from the group comprising a buddy list, an e-mail list of an e-mail system, an electronic phonebook, an electronic calendar system, and/or a dedicated database.

10. A consumer review method for soliciting reviews to a query comprising:
presenting a Web presentation to a client associated with a first user;
presenting a user interface to the client, wherein the user interface is configured to send a query about the Web presentation; and
sending the query to a set of clients associated with a set of users to solicit a set of reviews to the query from the set of users, wherein the set of users has a known relationship with the first user.

11. The method of claim 10, further comprising receiving an activation signal from the first user via the user interface to send the query to the set of clients, and in response to receiving the activation signal retrieving contact information for the set of clients.

12. The method of claim 11, further comprising retrieving the contact information from at least one of a trust network database, an e-mail list of an e-mail system, an electronic phonebook, an electronic calendar system, or a dedicated database.

13. The method of claim 11, wherein the contact information includes at least one of set of e-mail addresses, a set of IM (instant message) addresses, or set of VoIP (voice over internet protocol addresses) addresses.

14. The method of claim 10 further comprising presenting a set of reviews to the first user in a set of e-mails or in a Web presentation.

15. The method of claim 14, wherein each e-mail includes a link to the Web presentation of the set of reviews.

16. The method or claim 15, wherein the link includes a URL that points to a Web page that includes the set of reviews.

17. The method of claim 10, further comprising:
storing the query and the set of reviews in a review database;
receiving a request for presentation of the query and the set of reviews; and
presenting the query and the set of reviews in a Web presentation based on the received request.

18. The method of claim 10, wherein the query includes one or more of a query string, a link, a graphic, or a digital audio file.

19. The method of claim 10, further comprising:
receiving a query request from the first user via the user interface;
receiving a selection from the first user via the user interface for a group identifier for the set of users of a plurality of set of users;
retrieving contact information based on the group identifier; and
sending the query to the set of clients associated with the set of user selected by the first user.

20. A review solicitation system comprising:
at least one query system configured to receive a request for a query from a requester; and
a review server configured to publish a request page on the query system, wherein the request page is configured to receive the request, and wherein the review server is configured to automatically send the query to a set of clients associated with a set of reviewers, wherein the reviewers are members of a trust network.

21. The system of claim 20, further comprising a set of review systems, wherein each review system is associated with a reviewer, wherein each review system is configured:
to receive the query,
present the query to an associated reviewer,
receive a review for the query from this reviewer, and
send the review to at least one of the at least one query system or the review server.

22. The system of claim 21, further comprising a network configured to provide communication links between the query system, the review server, and the set of review systems.

23. The system of claim 20, wherein each review system is associated with contact information includes at least one of a set of e-mail addresses, a set of IM addresses, or set of VoIP addresses.

24. The system of claim 20, further comprising a contact data base configured to store the contact information, the contact database including an email list of an e-mail system, an electronic phonebook, an electronic calendar system, and/or a dedicated database.

25. The system of claim 20, wherein the request includes at least one of a query string, a graphic, a digital audio file, or a link to a page.

26. The system of claim 20, further comprising a VoIP server configured to send the query as a VoIP message.

27. The system of claim 20, further comprising an IM server configured to receive the query from the review server and to send the query to the reviewer's system as an IM message.
